(19) United States
(12) Patent Application Publication
(10) Pub. No.: US 2026/0145627 A1
(43) Pub. Date: May 28, 2026

(54) PERSONALIZATION SYSTEM AND PERSONALIZATION METHOD FOR VEHICLE

(71) Applicants: HYUNDAI MOTOR COMPANY, Seoul (KR); Kia Corporation, Seoul (KR)

(72) Inventors: Hanghang WANG, Shandong (CN); Jin Shun LI, Shandong (CN)

(73) Assignees: HYUNDAI MOTOR COMPANY, Seoul (KR); Kia Corporation, Seoul (KR)

(21) Appl. No.: 19/372,218

(22) Filed: Oct. 28, 2025

(30) Foreign Application Priority Data
Oct. 31, 2024 (CN) 202411545086.6

(51) Int. Cl. B60R 16/037; B60H 1/00; B60N 2/02

(52) U.S. Cl. CPC B60R 16/037; B60H 1/00971; B60N 2/0248

(57) ABSTRACT

In a personalization system and a personalization method for a vehicle, the communication device detects a position of a personal identification (ID) device carriable by a passenger and receives ID of the personal ID device from the personal ID device carriable by the passenger; and the controller determines a seat occupied by the passenger based on the position of the personal ID device detected by the communication device, compares the ID of the personal ID device received by the communication device with at least one pre-stored ID of the personal ID device linked with personalized settings corresponding to a vehicle seat, and generates a control signal for executing the personalized settings linked with a target ID in the determined seat in response to the ID of the personal ID device being the same as the target ID among the at least one pre-stored ID of the personal ID device.

### CROSS-REFERENCE TO RELATED APPLICATION

The present application claims priority to and the benefit of Chinese Patent Application No. 202411545086.6 filed with the Chinese National Intellectual Property Administration on Oct. 31, 2024, the entire contents of which are incorporated herein by reference.

### BACKGROUND OF THE PRESENT DISCLOSURE

### Field of the Present Disclosure

The present disclosure relates to a field of vehicle control technology, and more particularly, to a personalization system and a personalization method for a vehicle.

### Description of Related Art

Currently, a personalized linkage function for a vehicle may be implemented based on identification (ID) of a smart key. Specifically, the vehicle may identify IDs of different smart keys and turn on or off the personalized linkage function based on the ID of the identified smart key.

However, when a vehicle owner or a specific passenger utilizes an audio, video, navigation, and telematics (AVNT) device, a list of network broadcasting programs watched by the vehicle owner or the specific passenger, a network service in use, personal payment account information, and the like all belong to important personal privacy. If the personalized linkage function is implemented using the aforementioned method and when a chauffeur, a relative, or a friend drives the vehicle while sitting on a driver seat and the vehicle owner or the specific passenger sits on a different seat, the personalized linkage function based on the ID of the smart key may be executed at the driver seat, exposing privacy of the vehicle owner or the specific passenger.

Therefore, a personalization system and a personalization method that may implement the personalized linkage function at a boarding position of the passenger may be significantly necessary to protect the privacy of the passenger.

The above information disclosed in this Background section is provided only to assist in a better understanding of the background of the present disclosure, and may therefore include information that is not a part of the related art already known to those skilled in the art to which the present disclosure pertains.

### BRIEF SUMMARY

The present disclosure attempts to provide a personalization system and a personalization method for a vehicle that may implement a personalized linkage function only at a boarding position of a passenger by linking personalized settings to the boarding position of the passenger to protect privacy of the passenger.

According to various aspects of the present disclosure, provided is a personalization system for a vehicle, the system including a communication device and a controller, wherein the communication device detects a position of a personal identification (ID) device carriable by a passenger and receives ID of the personal ID device from the personal ID device carriable by the passenger; and the controller is configured to determine a seat occupied by the passenger based on the position of the personal ID device detected by the communication device, compare the ID of the personal ID device received by the communication device with at least one pre-stored ID of the personal ID device linked with personalized settings corresponding to a vehicle seat, and generate a control signal for executing the personalized settings linked with a target ID in the determined seat occupied by the passenger in response to the ID of the personal ID device received by the communication device being the same as the target ID among the at least one pre-stored ID of the personal ID device.

A type of the personalized settings may include at least one of seat settings, air conditioning settings, and sound settings, the seat settings my include at least one of settings for a front/rear position, a high/low position, a backrest inclination angle, a lumbar support position, a leg support position, a headrest position, seating comfort, massage intensity, and a massage type, the air conditioning settings may include at least one of settings for a target temperature, wind power, an air blowing type, an air vent angle, and PM2.5 filtering, and the sound settings may include at least one of settings for classical music, pop music, accent enhancement, and vocal enhancement among sound effects, intensity of a high-frequency range and a low-frequency range, and sound intensity.

The controller may be configured to determine whether the personal ID device is stationary when determining the seat occupied by the passenger, determine whether the personal ID device is continuously stationary for a reference time based on determining that the personal ID device is stationary, determine whether the currently detected position of the personal ID device falls within a vehicle seat region based on determining that the personal ID device is continuously stationary for the reference time, and determine the currently detected position of the personal ID device as the seat occupied by the passenger based on determining that the currently detected position of the personal ID device falls within the vehicle seat region.

The controller may be configured to determine whether the personal ID device is stationary based on whether a change occurs in the position of the personal ID device detected by the communication device when determining whether the personal ID device is stationary.

The controller may be configured to receive motion information of the personal ID device detected by a motion sensor disposed inside the personal ID device when determining whether the personal ID device is stationary, and determine whether the personal ID device is stationary based on the received motion information of the personal ID device.

The controller may be configured to determine the seat occupied by the passenger based on a seat close to a door switched to an open state and/or the seat occupied by the passenger if the currently detected position of the personal ID device does not fall within the vehicle seat region and falls within a region between front seats or a region between rear seats, and if one of the front doors or one of the rear doors is determined to be switched to the open state.

The controller may be configured to determine the position of the personal ID device initially detected in a vehicle interior as the seat occupied by the passenger if both the front doors or both the rear doors are switched to the open state.

The controller may be configured to determine whether a vehicle state satisfies a personalization execution condition before determining the seat occupied by the passenger, and determine that the vehicle state satisfies the personalization execution condition if the vehicle is in a parking gear, a parking brake is turned on, and power is in an ignition-on state.

The controller may be configured to control the communication device to detect the position of the personal ID device in response to determining that any door of the vehicle is switched from a closed state to an open state.

The controller may be configured to transmit a personalization execution notification message when the control signal is generated; determine whether a manipulation by the passenger for canceling the personalization execution is received; and transmit no control signal based on determining that the manipulation by the passenger for canceling the personalization execution is received.

According to another exemplary embodiment of the present disclosure, provided is a personalization method for a vehicle, the method including: detecting a position of a personal identification (ID) device carriable by a passenger; receiving ID of the personal ID device from the personal ID device carriable by the passenger; determining a seat occupied by the passenger based on the detected position of the personal ID device; comparing the received ID of the personal ID device with at least one pre-stored ID of the personal ID device linked with personalized settings corresponding to a vehicle seat; and generating a control signal for executing the personalized settings linked with a target ID in the determined seat occupied by the passenger in response to the ID of the personal ID device being the same as the target ID among the at least one pre-stored ID of the personal ID device.

A type of the personalized settings may include at least one of seat settings, air conditioning settings, and sound settings, the seat settings may include at least one of settings for a front/rear position, a high/low position, a backrest inclination angle, a lumbar support position, a leg support position, a headrest position, seating comfort, massage intensity, and a massage type, the air conditioning settings may include at least one of settings for a target temperature, wind power, an air blowing type, an air vent angle, and PM2.5 filtering, and the sound settings may include at least one of settings for classical music, pop music, accent enhancement, and vocal enhancement among sound effects, intensity of a high-frequency range and a low-frequency range, and sound intensity.

The determining a seat occupied by the passenger may include determining whether the personal ID device is stationary, determining whether the personal ID device is continuously stationary for a reference time based on determining that the personal ID device is stationary, determining whether the currently detected position of the personal ID device falls within a vehicle seat region based on determining that the personal ID device is continuously stationary for the reference time, and determining the currently detected position of the personal ID device as the seat occupied by the passenger based on determining that the currently detected position of the personal ID device falls within the vehicle seat region.

The determining of whether the personal ID device is stationary may include determining whether the personal ID device is stationary based on whether a change occurs in the detected position of the personal ID device.

The determining of whether the personal ID device is stationary may include receiving motion information of the personal ID device detected by a motion sensor disposed inside the personal ID device, and determining whether the personal ID device is stationary based on the received motion information of the personal ID device.

The determining a seat occupied by the passenger may include determining the seat occupied by the passenger based on a seat close to a door switched to an open state and/or the seat occupied by the passenger if the currently detected position of the personal ID device does not fall within the vehicle seat region and falls within a region between front seats or a region between rear seats, and if one of the front doors or one of the rear doors is determined to be switched to the open state.

The determining a seat occupied by the passenger may include determining the position of the personal ID device initially detected in a vehicle interior as the seat occupied by the passenger if both the front doors or both the rear doors are switched to the open state.

The method may further include: determining whether a vehicle state satisfies a personalization execution condition before the determining of the seat occupied by the passenger is performed; and determining that the vehicle state satisfies the personalization execution condition if the vehicle is in a parking gear, a parking brake is turned on, and power is in an ignition-on state.

The detecting of the position of the personal ID device may include detecting the position of the personal ID device in response to determining that any door of the vehicle is switched from a closed state to an open state.

The method may further include: transmitting a personalization execution notification message when the control signal is generated; determining whether a manipulation by the passenger for canceling the personalization execution is received; and transmitting no control signal based on determining that the manipulation by the passenger for canceling the personalization execution is received.

According to various aspects of the present disclosure, the personalized settings may be linked with the boarding position of the passenger, thereby implementing the personalized linkage function only at the boarding position of the passenger. Therefore, the privacy of the passenger may be protected.

Furthermore, According to various aspects of the present disclosure, the passenger manipulation procedure may be simplified through the various types of personalized settings based on the specifications of the conventional vehicle, thereby providing the convenient user experience.

Furthermore, According to various aspects of the present disclosure, by only changing the control logic, the user may be disposed with the plentiful personalized linkage function, and the luxurious feeling of the vehicle may be enhanced without increasing the cost.

Furthermore, any advantage which may be acquired or inferred from an exemplary embodiment of the present disclosure is directly or implicitly disclosed in the detailed description of an exemplary embodiment of the present disclosure. That is, various advantages inferred from an exemplary embodiment of the present disclosure are disclosed in the detailed description described below.

### BRIEF DESCRIPTION OF THE DRAWINGS

Hereinafter, various exemplary embodiments of the present disclosure are described in more detail with reference to the accompanying drawings. For clarity of description, the same parts in different drawings are indicated with the same reference number. It should be noted that the drawings are only illustrative and are not necessarily drawn to scale.

FIG. 1 is a block diagram of a personalization system for a vehicle according to an exemplary embodiment of the present disclosure.

FIG. 2 is a schematic diagram showing an example of a vehicle in which a communication device is disposed.

FIG. 3 is a schematic diagram showing an example of a vehicle interior.

FIG. 4 is a flowchart of a personalization method for a vehicle according to an exemplary embodiment of the present disclosure.

FIG. 5A, FIG. 5B, FIG. 5C, and FIG. 5D are flowcharts of a personalization method for a vehicle according to an exemplary embodiment of the present disclosure.

### DETAILED DESCRIPTION

Hereinafter, various exemplary embodiments of the present disclosure are described in detail. These embodiments are implemented based on a technical approach of the present disclosure, and a detailed implementation method and a specific manipulation process are disclosed. However, the scope of the present disclosure is not limited to the following embodiments.

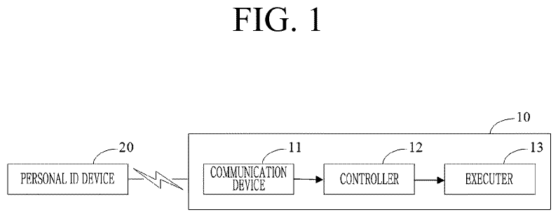

FIG. 1 is a block diagram of a personalization system for a vehicle according to an exemplary embodiment of the present disclosure. As shown in FIG. 1, a personalization system 10 for a vehicle according to an exemplary embodiment of the present disclosure may include a communication device 11, a controller 12, and an executer 13.

The communication device 11 may detect a position of a personal identification (ID) device 20 carried by a passenger by communicating with the personal ID device 20 and receive identification (ID) of the personal ID device 20 from the personal ID device 20. In the present way, the personalization system 10 according to an exemplary embodiment of the present disclosure may detect the passenger (specifically, the position and the identification of the passenger) corresponding to the personal ID device 20 as a basis for implementing a personalized linkage function.

The personal ID device 20 may be a remote control key (e.g., a frequency operated button (FOB)) or a smart key embedded in a smartphone. However, a type of the personal ID device 20 is only an example, and the personal ID device 20 may be configured in any form as long as the personalization system may detect the passenger carrying the personal ID device 20.

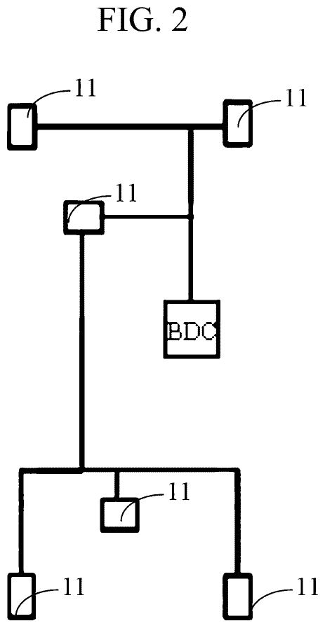

FIG. 2 is a schematic diagram showing an example of a vehicle in which the communication device is disposed. As shown in FIG. 2, the communication device 11 may be disposed in a plurality of positions of the vehicle. The communication device 11 may be disposed in at least one position among a left front portion, a right front portion, a left rear portion, and a right rear portion of a vehicle body and a vehicle interior.

A body domain control (BDC) may transmit a transmission request signal to the communication device 11. When the communication device 11 receives the transmission request signal from the BDC, each communication device 11 may transmit a request signal. The request signal may define a detection region having a predetermined distance as a transmission radius, and the defined detection region may cover a vehicle exterior and the entire vehicle interior within a predetermined range. When the personal ID device 20 enters the detection region defined by the request signal, the personal ID device 20 may transmit a response signal in response to the request signal. The communication device 11 may receive the response signal from the personal ID device 20. The plurality of communication devices 11 may be spatially distributed, and thus may all communicate with the personal ID device 20. Accordingly, one of the communication devices 11 may be configured to determine the position of the personal ID device 20 using a method such as triangulation by measuring a time gap between the request signal and the response signal between the personal ID device 20 and each communication device 11. However, the present disclosure is not limited thereto, and the communication device 11 may be configured to determine the position of the personal ID device 20 based on other positioning algorithms.

The response signal from the personal ID device 20 may include an ID of the personal ID device 20, and the communication device 11 may thus receive the ID of the personal ID device 20 from the personal ID device 20.

For example, the personalized linkage function may always be implemented in the vehicle interior. Therefore, to simplify a control logic, the communication device 11 may detect the position of the personal ID device 20 only when the personal ID device 20 enters the vehicle interior. For example, whether the personal ID device 20 enters the vehicle interior may be determined based on a switch between an open state and a closed state of a vehicle door. That is, when any door of the vehicle is switched from the closed state to the open state, indicating that the passenger enters the vehicle interior, it is highly likely that the personal ID device 20 simultaneously enters the vehicle interior. Here, the communication device 11 may detect the position of the personal ID device 20. Furthermore, the BDC may identify switching of the door state. When it is determined by the BDC that any door of the vehicle is switched from the closed state to the open state, the BDC may transmit the transmission request signal to the communication device 11, as described above. Accordingly, the communication device 11 may detect the position of the personal ID device 20.

The communication device 11 may be any one of an ultra wide-band communication (UWB) antenna, a Bluetooth low energy (BLE) antenna, a wireless power consortium (WPC) antenna, or a Near Field Communication (NFC) antenna.

The controller 12 may be electrically connected to the communication device 11 and receive the position of the personal ID device 20 and the ID of the personal ID device 20 detected from the communication device 11. The controller 12 may then determine a seat occupied by the passenger based on the position of the personal ID device 20 detected by the communication device 11. The controller 12 may be implemented through the BDC described above.

During a boarding process of the passenger, the personal ID device 20 carried by the passenger may move as the passenger moves, and only when the passenger sits on one of vehicle seats, the personal ID device 20 carried by the passenger may maintain a stationary state. Therefore, when the personal ID device 20 maintains the stationary state, the controller 12 may be configured to determine the seat occupied by the passenger.

The controller 12 may be configured to determine whether the personal ID device 20 is stationary upon determining the seat occupied by the passenger.

In an exemplary embodiment of the present disclosure, the controller 12 may be configured to determine whether the personal ID device 20 is stationary based on whether a change occurs in the position of the personal ID device 20 detected by the communication device 11 (e.g., the UWB antenna or the BLE antenna). In another exemplary embodiment of the present disclosure, the controller 12 may receive motion information of the personal ID device 20 detected by a motion sensor disposed inside the personal ID device 20, and determine whether the personal ID device 20 is stationary based on the received motion information of the personal ID device 20.

The controller 12 may be configured to determine whether the personal ID device 20 is continuously stationary for a reference time if it is determined that the personal ID device 20 is stationary. The controller 12 may be configured to determine that the personal ID device 20 maintains the stationary state if it is determined that the personal ID device 20 is continuously stationary for the reference time.

In an exemplary embodiment of the present disclosure, the controller 12 may be implemented by a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention.

After the personal ID device 20 is determined to maintain the stationary state, the controller 12 may be configured to determine whether the currently detected position of the personal ID device 20 falls within a vehicle seat region. The vehicle seat region may include a region for each vehicle seat.

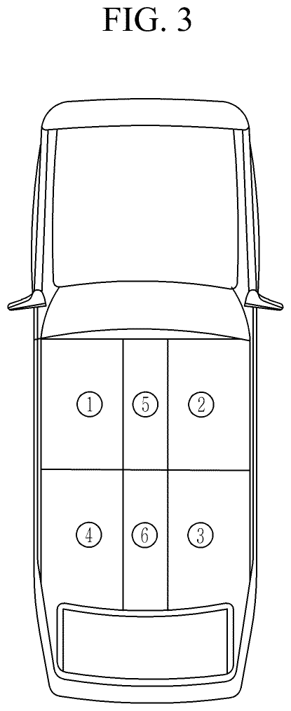

FIG. 3 is a schematic diagram showing an example of the vehicle interior. For example, FIG. 3 shows the vehicle seat region including regions \textcircled{1} to \textcircled{4}, region \textcircled{1} represents a driver seat, region \textcircled{2} represents a passenger seat, region \textcircled{3} represents a right rear seat, and region \textcircled{4} represents a left rear seat.

If the controller 12 determines that the currently detected position of the personal ID device 20 falls within the vehicle seat region, the position of the personal ID device 20 may be exactly on the seat occupied by the passenger. Therefore, the controller 12 may be configured to determine the currently detected position of the personal ID device 20 as being on the seat occupied by the passenger. For example, if the currently detected position of the personal ID device 20 is region \textcircled{1}, the present fact indicates that the driver seat is occupied by the passenger carrying the personal ID device 20, and the seat occupied by the passenger may thus be determined as the driver seat.

The controller 12 may be configured to determine the seat occupied by the passenger based on a seat close to the door switched to the open state and/or the seat occupied by the passenger if the controller 12 determines that the currently detected position of the personal ID device 20 does not fall within the vehicle seat region (i.e., regions \textcircled{1} to \textcircled{4} shown in FIG. 3) and falls within a region between front seats (i.e., region \textcircled{5} in FIG. 3) or a region between the rear seats (i.e., region \textcircled{6} in FIG. 3), and if one of front doors or one of rear doors is switched to the open state.

If the currently detected position of the personal ID device 20 falls within region \textcircled{5}, the driver seat or the passenger seat may be occupied by the passenger carrying the personal ID device 20. For example, if the door close to the driver seat is switched from the closed state to the open state, the controller 12 may be configured to determine the driver seat as the seat occupied by the passenger because a seat adjacent to the door close to the driver seat is the driver seat. Furthermore, the vehicle may be driven only when the driver seat is occupied by the passenger. Therefore, in the instant case, the controller 12 may not need to determine whether the driver seat is occupied by the passenger. However, a seat adjacent to a door close to the passenger seat is the passenger seat if only the door close to the passenger seat is switched from the closed state to the open state. Therefore, in the instant case, the controller 12 may need to further determine whether the passenger seat is occupied by the passenger. If the passenger seat is occupied by the passenger, the controller 12 may be configured to determine the seat occupied by the passenger as the passenger seat.

As described above, the switching of the door state may be checked by the BDC. Whether a seat is occupied by the passenger may be detected by at least one sensor of a weight sensor disposed on the seat and a camera or a proximity sensor disposed in the vehicle interior, and the at least one sensor may transmit a detection result to the controller 12.

However, the controller 12 may be configured to determine the position of the personal ID device 20 that is initially detected in the vehicle interior as being on the seat occupied by the passenger if both the front doors (i.e., the door close to the driver seat and the door close to the passenger seat) are switched to the open state. For example, if the communication device 11 initially detects the personal ID device 20 at the region \textcircled{1} in the vehicle interior and then detects the personal ID device 20 at the region \textcircled{5} when the personal ID device maintains the stationary state, this indicates that the passenger gets into the vehicle, then sits on the driver seat, and then places the personal ID device 20 at the region \textcircled{5}. Accordingly, the controller 12 may be configured to determine the seat occupied by the passenger as the driver seat.

If the currently detected position of the personal ID device 20 falls within the region \textcircled{6}, the left rear seat or the right rear seat may be occupied by the passenger carrying the personal ID device 20. If only a left rear door is switched from the closed state to the open state and the left rear seat is occupied by the passenger, the controller 12 may be configured to determine the seat occupied by the passenger as the left rear seat. However, the passenger sitting on the rear seat may change the position, and the passenger may sit on the right rear seat although the passenger gets into the vehicle through the left rear door. Therefore, when the left rear seat is not occupied by the passenger, the controller 12 needs to further detect whether the right rear seat is occupied by the passenger. If the right rear seat is occupied by the passenger, the controller 12 may be configured to determine the seat occupied by the passenger as the right rear seat. If only a right rear door is switched from the closed state to the open state and the right rear seat is occupied by the passenger, the controller 12 may be configured to determine the seat occupied by the passenger as the right rear seat. If the right rear seat is not occupied by the passenger and the left rear seat is occupied by the passenger, the controller 12 may be configured to determine the seat occupied by the passenger as the left rear seat.

Similarly, if both the rear doors (i.e., the left rear door and the right rear door) are switched to the open state, the controller 12 may be configured to determine the position of the personal ID device 20 that is initially detected in the vehicle interior as the seat occupied by the passenger.

For example, the controller 12 may be configured to determine whether a vehicle state satisfies a personalization execution condition before determining the seat occupied by the passenger. If it is determined that the vehicle is in a parking gear, a parking brake is turned on, and power is in an ignition-on (IGN ON) state, the controller 12 may be configured to determine that the vehicle state satisfies the personalization execution condition and determine the seat occupied by the passenger. That is, to ensure vehicle driving safety, the personalized linkage function needs to be turned on before the vehicle is driven, and may not to be turned on during vehicle driving.

According to an exemplary embodiment of the present disclosure, the controller 12 may compare the ID of the personal ID device 20 received by the communication device 11 with pre-stored ID of the personal ID device 20 linked with personalized settings corresponding to the at least one vehicle seat.

Taking a vehicle including four seats in FIG. 3 as an exemplary embodiment of the present disclosure, Table 1 shows a linking relationship between the ID of the personal ID device 20 and the personalized settings (including at least one of type 1, type 2, and type 3) corresponding to the at least one vehicle seat (i.e., at least one of the driver seat, the passenger seat, the left rear seat, and the right rear seat).

ID of the personal
ID device

| | | |
|---|---|---|
| Personalized Seat Settings | ID A | ID B |

| | | | |
|---|---|---|---|
| Driver seat | type 1 | X | L |
| | type 2 | Y | M |
| | type 3 | Z | N |
| Passenger seat | type 1 | — | L |
| | type 2 | — | M |
| | type 3 | — | N |
| Left rear seat | type 1 | O | L |
| | type 2 | P | M |
| | type 3 | Q | N |
| Right rear seat | type 1 | R | — |
| | type 2 | S | — |
| | type 3 | T | — |

In response to a target ID among the pre-stored IDs of the personal ID devices 20 being the same as the ID of the personal ID device 20 received by the communication device 11, the controller 12 may be configured to generate a control signal for executing the personalized settings linked with the target ID in the determined seat occupied by the passenger. The controller 12 may be implemented in a connected car navigation & cockpit (CCNC) device or an audio, video, navigation, and telematics (AVNT) device.

As shown in Table 1, in a specific case, the ID of the personal ID device 20 and the pre-stored ID of the personal ID device 20 may be the same, and the related personalized settings may exist corresponding to the determined seat occupied by the passenger. For example, if the ID of the personal ID device 20 received by the controller 12 is ID A, and the determined seat occupied by the passenger is the driver seat, the controller 12 may be configured to determine that the personalized settings to be executed are X, Y, and Z according to Table 1. Therefore, the controller 12 may be configured to generate the control signal for executing the personalized settings of X, Y, and Z in the driver seat.

In another case, the ID of the personal ID device 20 and the pre-stored ID of the personal ID device 20 may be the same, but the related personalized settings may not exist corresponding to the determined seat occupied by the passenger. For example, if the ID of the personal ID device 20 received by the controller 12 is ID A, and the determined seat occupied by the passenger is the passenger seat, the controller 12 may be configured to determine that there are no personalized settings to be executed according to Table 1. In the instant case, there is no personalized settings to be executed.

In a related art, the personalized linkage function may be implemented based on only the ID of the personal ID device 20. However, in an exemplary embodiment of the present disclosure, the personalized settings may be linked with the boarding position of the passenger. For example, if a chauffeur, a relative, or a friend drives the vehicle while sitting on the driver seat, and the passenger (carrying the FOB key whose ID is ID B) sits on another vehicle seat (e.g., the left rear seat), personalized settings of L, M, and N may be implemented in the left rear seat instead of the driver seat, thereby protecting privacy of the passenger.

Referring back to FIG. 1, the controller 12 may be electrically connected to the executer 13 and transmit the generated control signal to the executer 13. The executer 13 may perform the execution based on the received control signal. Furthermore, the executer 13 may be linked with a type of personalized settings. According to an exemplary embodiment of the present disclosure, type 1 of personalized settings may be seat settings, type 2 of personalized settings may be air-conditioning settings, and type 3 of personalized settings may be sound settings. Accordingly, the executer 13 may be an executer including an actuator configured for adjusting the seat, the air-conditioning, or the sound. The executers configured for adjusting the seat, the air-conditioning, and the sound may be implemented as a seat control device, an air-conditioning control device, and a sound control device, respectively.

The seat control device may adjust each seat in the vehicle interior. Therefore, if the seat occupied by the passenger is determined, the determined seat occupied by the passenger may be directly determined to be disposed in a region for executing the seat settings. The seat settings may include at least one of settings for the seat such as front/rear positions, high/low positions, a backrest inclination angle, a lumbar support position, a leg support position, a headrest position, seating comfort, massage intensity, or a massage type.

The vehicle interior may include a plurality of air-conditioning regions. The air-conditioning regions may be classified based on an air vent position thereof. In general, an air vent may be disposed around each seat, and the air-conditioning control device may adjust air in each air-conditioning region. Therefore, the seat occupied by the passenger may be determined, and the air-conditioning region corresponding to the seat occupied by the passenger may then be determined as a region for executing the air-conditioning settings. The air-conditioning settings may include at least one of settings for a target temperature, wind power, an air blowing type, an air vent angle, and PM2.5 filtering.

The vehicle interior may include a plurality of sound regions. The sound regions may be classified based on an audio output device position thereof. In general, in addition to an audio output device being disposed around each seat, the audio output device may also be disposed on a headrest of each seat. The sound control device may adjust sound in each sound region. Therefore, the seat occupied by the passenger may be determined, and the sound region for the seat occupied by the passenger may then be determined to be a region for executing the sound settings. The sound settings may include at least one of settings for sound effects such as classical music, pop music, accent enhancement, vocal enhancement, intensity of a high-frequency range and a low-frequency range, and sound intensity.

The personalization system 10 according to an exemplary embodiment of the present disclosure may provide a convenient user experience by simplifying a passenger manipulation procedure through the various types of personalized settings based on specifications of a conventional vehicle. However, the types of personalized settings and the contents for each type of personalized settings are only examples, and the types of personalized settings and the corresponding contents may be configured in any form as long as such types and contents correspond to a function implementable in the vehicle interior. For example, other forms may include interface themes on a dashboard or the CCNC device, music playlists, electronic payments, or the like.

When performing an exemplary embodiment of the present disclosure, the passenger may personalize the seat currently occupied by the passenger, the air-conditioning region and the sound region, in which the seat is disposed. For example, the passenger may adjust the left rear seat to have a seat height of 50 cm, a distance of 40 cm from a center console, and a seat backrest inclination angle of 100°. The passenger may adjust the air-conditioning region in which the left rear seat is disposed to set a target temperature to 25° C. The passenger may adjust the sound region in which the left rear seat is disposed to set the sound effect to the classical music and the sound intensity to 60 dB.

As described above, the controller 12 may be implemented as the AVNT device or the CCNC device, and the AVNT or the CCNC device may include a user interface configured for interacting with the passenger. For example, for the CCNC device, after the passenger completes the settings, the user interface of the CCNC device may request the passenger to link current personalized settings (i.e., settings for the seat occupied by the passenger, the air conditioning, and the sound) with the seat currently occupied by the passenger and the ID of the personal ID device (e.g., the FOB key) carried by the passenger.

The CCNC device may pre-store the ID of at least one FOB key. The FOB key may be connected to the CCNC device by use of Bluetooth or the like, the IDs of all FOB keys connected to the CCNC device may be stored in the CCNC device, and displayed on the user interface of the CCNC device through a user settings menu (USM).

Furthermore, the CCNC device may pre-store vehicle seat specifications, and each vehicle seat may also be displayed on the user interface of the CCNC device through the USM.

Therefore, during a linking process, the passenger may complete a linking manipulation by selecting the currently occupied seat (i.e., the left rear seat) and the ID (e.g., ID A) of the FOB key carried by the passenger from menu items of the USM. Furthermore, the passenger may also turn on or off the above-set menu items through the user interface (i.e., select whether to use the linking relationship).

The linking relationship may be recorded in Table 1. For example, in Table 1, O indicates the settings such as “the seat height of 50 cm, the distance of 40 cm from the center console, and the seat backrest inclination angle of 100°”, P indicates the setting such as “the target temperature of 25° C.”, and Q indicates the settings such as “the classical music effect and the sound intensity of 60 dB”. Table 1, in which at least one linking relationship is recorded, may be stored in the CCNC device.

In the present way, when the passenger enters the vehicle again and sits on the left rear seat, the menu items may be turned on. Here, the personalized settings linked with the left rear seat and the ID of the FOB key carried by the passenger may be O, P, and Q. The left rear seat may be automatically adjusted to the height of 50 cm, the distance of 40 cm from the center console, and the seat backrest inclination angle of 100°. The adjustment of air in the air-conditioning region, in which the left rear seat is disposed, may be turned on, and the target temperature may be adjusted to 25° C. The audio output device in the sound region in which the left rear seat is disposed may be turned on, the sound effect may be adjusted to the classical music, and the sound intensity may be adjusted to 60 dB. In general, a rear seat display may be disposed on a rear side of the headrest or backrest of the front seat, viewable by the passenger sitting on the rear seat. Accordingly, the passenger may watch the list of network broadcasting programs based on the sound settings from the seat occupied by the passenger, use the network service, or make a personal payment.

Furthermore, although the personalized settings are already executed, the passenger may manually adjust a vehicle function again, thereby changing the personalized linkage function. In the instant case, the manual adjustment by the passenger needs to be executed first, and no additional personalized settings need not to be executed. In the present way, when the controller 12 generates the control signal, the controller 12 may be configured to determine whether the personalized settings are executed in a current ignition cycle of the vehicle. If the controller 12 is configured to determine that the personalized settings are executed in the current ignition cycle of the vehicle, the controller 12 does not transmit the control signal.

According to an exemplary embodiment of the present disclosure, the controller 12 may transmit a personalized settings execution notification message when the controller 12 generates the control signal. The controller 12 may be configured to determine whether a manipulation by the passenger for canceling of the execution of the personalized settings is received. The controller 12 may transmit no control signal if it is determined that the manipulation by the passenger for canceling the execution of the personalized settings is received.

The notification message may be a generated sound or a displayed image. If the controller 12 is the CCNC device, the CCNC device may pop-up a window and display the notification message in the window to inform the passenger that the personalized settings (specifically, the settings for the seat, the air conditioning, and the sound) is to be executed. Furthermore, the notification message may include specific contents of the settings to be executed. Alternatively, the CCNC device may play the notification message through the audio output device disposed in the seat occupied by the passenger, which is advantageous for informing the passenger in the rear seat of the notification message.

The passenger may cancel the personalization execution. For example, the passenger may cancel the personalization execution by a manipulation in which the passenger speaks a voice command. Correspondingly, the CCNC device may activate a voice identification function, and the voice identification function may be used to identify contents of the voice command. If the CCNC device identifies the contents of the voice command by the passenger as the personalization execution cancellation, the CCNC device does not transmit the control signal, and accordingly, the personalization is not executed. Conversely, if the CCNC device does not receive the voice command by the passenger or identifies the contents of the voice command as not being the personalization execution cancellation, the CCNC device may transmit the control signal to the seat control device, the air-conditioning control device, and the audio control device, respectively, thereby executing the personalization.

However, the manipulation in which the passenger speaks the voice command is only an example, the passenger may also cancel the personalization execution by pressing a button. For example, the button may be a hard key button including a mechanical structure or a soft key button displayed on the display.

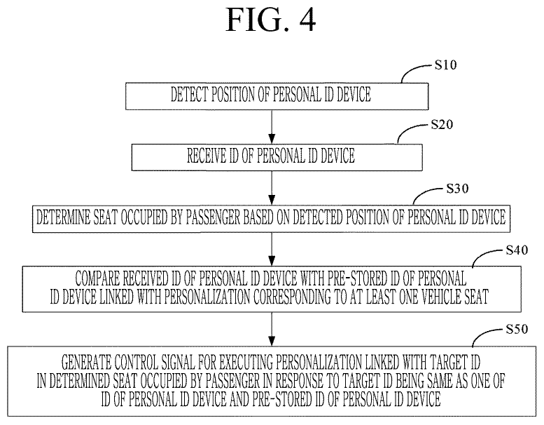

FIG. 4 is a flowchart of a personalization method for a vehicle according to an exemplary embodiment of the present disclosure. As shown in FIG. 4, the personalization method for the vehicle according to an exemplary embodiment of the present disclosure includes: detecting the position of the personal ID device 20 carried by the passenger at step S10; receiving the ID of the personal ID device 20 from the personal ID device 20 carried by the passenger at step S20; determining the seat occupied by the passenger based on the detected position of the personal ID device 20 at step S30; comparing the received ID of the personal ID device 20 with the pre-stored ID of the personal ID device linked with the personalized settings corresponding to at least one vehicle seat at step S40; and generating the control signal for executing the personalized settings linked with the target ID in the determined seat occupied by the passenger in response to the ID of the personal ID device 20 being the same as the target ID among the pre-stored IDs of the personal ID devices 20 at step S50.

However, a personalization method for a vehicle according to the related art may implement the personalized linkage function based only on the ID of the personal ID device. For example, the personalization method for the vehicle according to the related art includes: receiving the ID of the personal ID device from the personal ID device; comparing the received ID of the personal ID device with the pre-stored IDs of the personal ID devices linked with the personalized settings; and generating the control signal for executing the personalized settings linked with the pre-stored ID of the personal ID device in response to the ID of the personal ID device being the same as the pre-stored ID of the personal ID device.

Compared with the personalization method for the vehicle according to the related art, in an exemplary embodiment of the present disclosure, the personalization may be linked with the boarding position of the passenger. When the chauffeur, the relative, the friend, or the like may drive the vehicle while sitting on the driver seat and the passenger (here, the ID of the personal ID device 20 is one of the pre-stored IDs of the personal ID devices 20) sits on another seat of the vehicle, the linked personalized settings may be implemented in the seat occupied by the passenger rather than the driver seat. Therefore, the privacy of the passenger may be protected.

According to an exemplary embodiment of the present disclosure, the type of personalized settings may include at least one of the seat settings, the air conditioning settings, and the sound settings. The seat settings may include at least one of the settings for the seat, such as the front/rear position, the high/low position, the backrest inclination angle, the lumbar support position, the leg support position, the headrest position, the seating comfort, the massage intensity, and the massage type. The air conditioning settings may include at least one of the settings for the target temperature, the wind power, the air blowing type, the air vent angle, and the PM2.5 filtering. The sound settings may include at least one of the settings for the sound effects such as the classical music, the pop music, the accent enhancement, the vocal enhancement, the intensity of the high-frequency range and the low-frequency range, and the sound intensity.

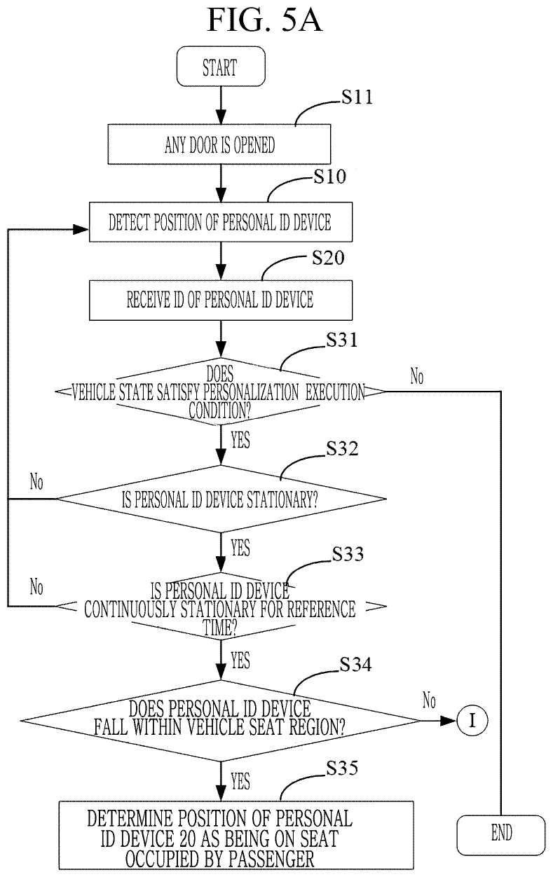

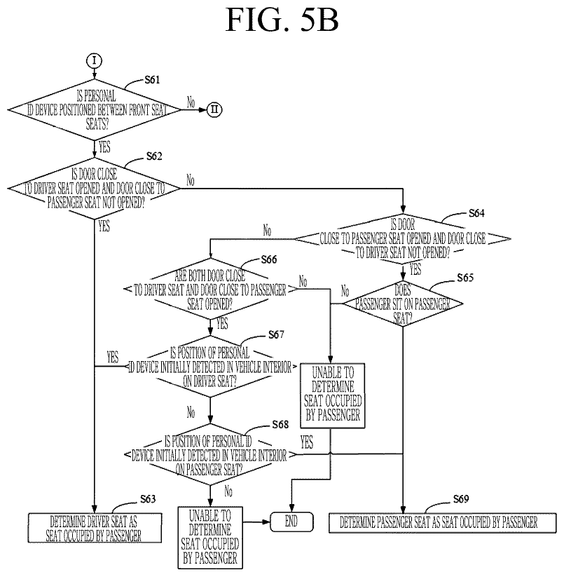

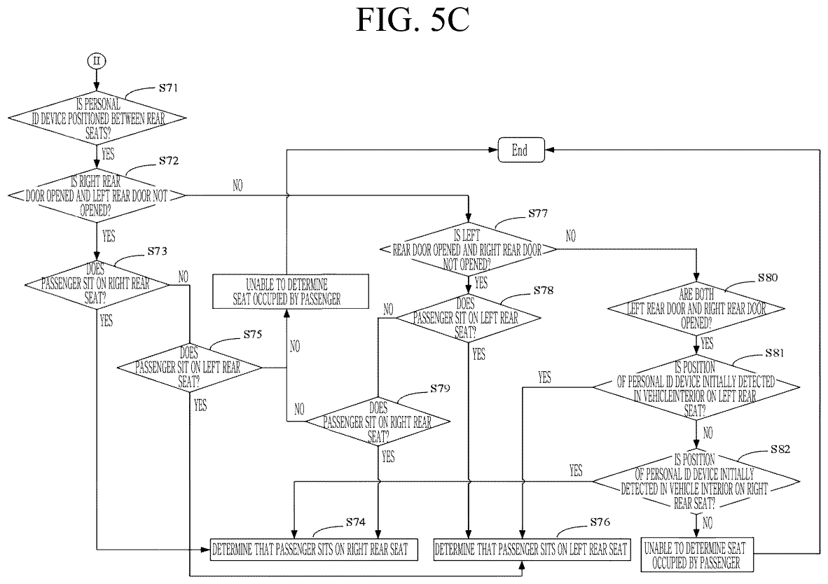

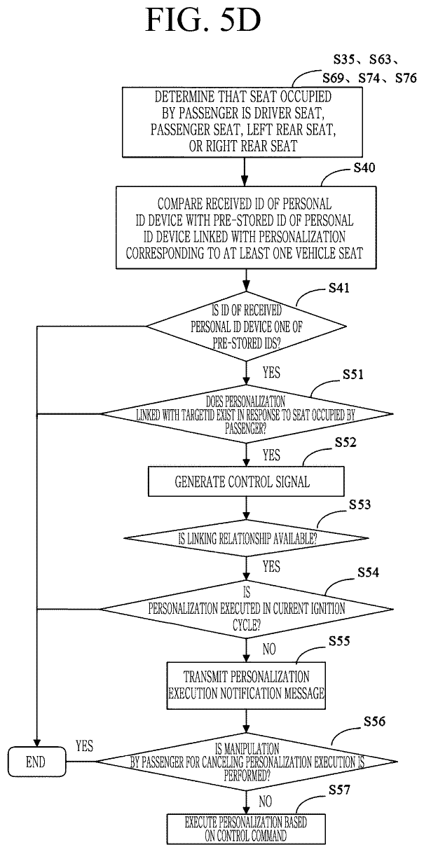

FIG. 5A, FIG. 5B, FIG. 5C, and FIG. 5D are flowcharts of the personalization method for the vehicle according to an exemplary embodiment of the present disclosure. As shown in FIG. 5A, the detecting the position of the personal ID device 20 at the step S10 may include the detecting the position of the personal ID device 20 at the step S10 when it is determined that any door of the vehicle is switched from the closed state to the open state at step S11. Simultaneously, the ID of the personal ID device 20 may be received from the personal ID device 20 at the step S20.

Before the determining of the seat occupied by the passenger based on the detected position of the personal ID device 20 at the step S30, whether the vehicle state satisfies the personalization execution condition may be determined at step S31. For example, if the vehicle is in the parking gear, the parking brake is on, and the power is in the ignition state, the vehicle state may be determined to satisfy the personalization execution condition.

If the vehicle state is determined to satisfy the personalization execution condition (“yes” at the step S31), the determining of the seat occupied by the passenger based on the detected position of the personal ID device 20 at the step S30 may include determining whether the personal ID device 20 is stationary at step S32.

The determining of whether the personal ID device 20 is stationary at the step S32 may include determining whether the personal ID device 20 is stationary based on whether the change occurs in the detected position of the personal ID device 20. Alternatively, the determining of whether the personal ID device 20 is stationary at the step S32 may include receiving the motion information of the personal ID device 20 detected by the motion sensor disposed inside the personal ID device 20, and determining whether the personal ID device 20 is stationary based on the received motion information of the personal ID device 20.

It may be determined whether the personal ID device 20 is continuously stationary for the reference time at step S33 if it is determined that the personal ID device 20 is stationary (“yes” at the step S32).

If the personal ID device 20 is determined to be continuously stationary for the reference time (“yes” at the step S33), it indicates that the personal ID device 20 is maintained in the stationary state. Here, it may be determined whether the currently detected position of the personal ID device 20 falls within the vehicle seat region at step S34. The currently detected position of the personal ID device 20 is determined as the seat occupied by the passenger at step S35 if the currently detected position of the personal ID device 20 is determined to fall within the vehicle seat region (“yes” at the step S34).

However, the seat occupied by the passenger may be determined based on the seat close to the door switched to the open state and/or the seat occupied by the passenger if the currently detected position of the personal ID device 20 is determined not to fall within the vehicle seat region (“no” at the step S34) and fall within the region between the front seats or the region between the rear seats, and if one of the front doors or the rear doors is switched to the open state. The position of the personal ID device 20 initially detected in the vehicle interior may be determined as the seat occupied by the passenger if both the front doors or both the rear doors are switched to the open state.

Hereinafter, referring to FIGS. 5B and 5C, the determining of the seat occupied by the passenger when the position of the personal ID device does not fall within the vehicle seat region will be described in detail.

If the currently detected position of the personal ID device 20 is determined not to fall within the region in which the passenger sits (“no” at the step S34), it may be determined whether the currently detected position of the personal ID device 20 falls within the region between the front seat seats (i.e., the region between the driver seat and the passenger seat) at step S61.

If the currently detected position of the personal ID device 20 is determined to fall within the region between the front seat seats (“yes” at the step S61), it may be determined whether only the door close to the driver seat is switched to the open state at step S62.

If only the door close to the driver seat is determined to be switched to the open state (“yes” at the step S62), the driver seat may be determined to be the seat occupied by the passenger at step S63.

If it is determined that only the door close to the driver seat is not switched to the open state (“no” at the step S62), it may be determined whether only the door close to the passenger seat is switched to the open state at step S64.

If it is determined that only the door close to the passenger seat is switched to the open state (“yes” at the step S64), it may be detected whether the passenger sits on the passenger seat at step S65. If it is detected that the passenger sits on the passenger seat (“yes” at the step S65), the passenger seat may be determined as the seat occupied by the passenger at step S69.

If it is determined that only the door close to the passenger seat is not switched to the open state (“no” at the step S64), it may be determined whether both the door close to the driver seat and the door close to the passenger seat are switched to the open state at step S66. If it is determined that both the door close to the driver seat and the door close to the passenger seat are switched to the open state (“yes” at the step S66), it may be determined whether the position of the personal ID device 20 initially detected in the vehicle interior is on the driver seat at step S67.

If the position of the personal ID device 20 initially detected in the vehicle interior is determined to be the driver seat (“yes” at the step S67), it may be determined that the driver seat is the seat occupied by the passenger at the step S63.

If the position of the personal ID device 20 initially detected in the vehicle interior is determined not to be on the driver seat (“no” at the step S67), it may then be determined whether the position of the personal ID device 20 initially detected in the vehicle interior is on the passenger seat at step S68. If the position of the personal ID device 20 initially detected in the vehicle interior is determined to be on the passenger seat (“yes” at the step S68), it may then be determined that the passenger seat is the seat occupied by the passenger at the step S69.

Returning to the step S61, if the currently detected position of the personal ID device 20 is determined not to fall within the region between the front seats (“no” at the step S61), it may then be determined whether the currently detected position of the personal ID device 20 falls within the region between the rear seats (e.g., the region between the right rear seat and the left rear seat) at step S71, as shown in FIG. 5C.

If the currently detected position of the personal ID device 20 is determined to fall within the region between the rear seats (“yes” at the step S71), it may be determined whether only the right rear door of the vehicle is switched to the open state at step S72. If it is determined that only the right rear door is switched to the open state (“yes” at the step S72), it may be determined whether the passenger sits on the right rear seat at step S73. If it is determined that the passenger sits on the right rear seat (“yes” at the step S73), the right rear seat may be determined as the seat occupied by the passenger at step S74. If it is determined that no passenger sits on the right rear seat (“no” at the step S73), it may be determined whether the passenger sits on the left rear seat at step S75. If it is determined that the passenger sits on the left rear seat (“yes” at the step S75), the left rear seat may be determined as the seat occupied by the passenger at step S76.

If it is determined that only the right rear door is not switched to the open state (“no” at the step S72), it may be determined whether only the left rear door is switched to the open state at step S77. If it is determined that only the left rear door is switched to the open state (“yes” at the step S77), it may be determined whether the passenger sits on in the left rear seat at step S78. If it is determined that the passenger sits on the left rear seat (“yes” at the step S78), the left rear seat may be determined as the seat occupied by the passenger at the step S76. If it is determined that no passenger sits on the left rear seat (“no” at the step S78), it may be determined whether the passenger sits on the right rear seat at step S79. If it is determined that the passenger sits on the right rear seat (“yes” at the step S79), the right rear seat may be determined as the seat occupied by the passenger at the step S74.

If it is determined that only the left rear door is not switched to the open state (“no” at the step S77), it may be determined whether both the left rear door and the right rear door are switched to the open state at step S80. If it is determined that both the left rear door and the right rear door are switched to the open state (“yes” at the step S80), it may be determined whether the position of the personal ID device 20 initially detected in the vehicle interior is on the left rear seat at step S81.

If it is determined that the position of the personal ID device 20 initially detected in the vehicle interior is on the left rear seat (“yes” at the step S81), the left rear seat may be determined as the seat occupied by the passenger at the step S76.

If it is determined that the position of the personal ID device 20 initially detected in the vehicle interior is not on the left rear seat (“no” at the step S81), it may be determined whether the position of the personal ID device 20 initially detected in the vehicle interior is on the right rear seat at step S82. If it is determined that the position of the personal ID device 20 initially detected in the vehicle interior is on the right rear seat (“yes” at the step S82), the right rear seat may be determined as the seat occupied by the passenger at the step S74.

As shown in FIG. 5D, the seat occupied by the passenger may be determined as one of the driver seat, the passenger seat, the right rear seat, and the left rear seat at any one of the steps S35, S63, S69, S74, and S76, and the received ID of the personal ID device 20 may then be compared with the pre-stored ID of the personal ID device 20 at the step S40 to determine whether the received ID of the personal ID device is one of the pre-stored IDs of the personal ID devices at step S41. If the received ID of the personal ID device 20 is determined to be one of the pre-stored IDs of the personal ID devices 20 (“yes” at the step S41), if the received ID of the personal ID device 20 is determined to be the target ID among the pre-stored IDs of the personal ID devices 20, it may be determined whether the personalized settings linked with the target ID exists corresponding to the seat occupied by the passenger at step S51.

When it is determined that the personalized settings linked with the target ID exists corresponding to the seat occupied by the passenger (“yes” at the step S51), the control signal may be generated at step S52 to execute the personalized settings.

It may be determined whether the linking relationship between the seat occupied by the passenger corresponding to the ID of the personal ID device 20 and the personalized settings is available at step S53. If the linking relationship is determined to be available (“yes” at the step S53), whether the personalized settings are executed in the current ignition cycle of the vehicle may be determined at step S54. The personalization execution notification message may be transmitted at step S55 if the personalized settings are determined not to be executed in the current ignition cycle of the vehicle (“no” at the step S54). For example, the personalization notification message may be the generated sound or the displayed image. The personalization notification message may be transmitted, and whether the manipulation by the passenger for canceling the personalization execution is received may then be determined at step S56. The manipulation by the passenger for canceling the personalization execution may be the manipulation in which the passenger speaks the voice command.

If the manipulation by the passenger for canceling the personalization execution is determined to be received (“yes” at the step S56), the personalized settings are not executed. If the manipulation by the passenger for canceling the personalization execution is determined not to be received (“no” at the step S56), the personalized settings may be executed based on the control command at step S57.

The personalization system and the personalization method according to the exemplary embodiments of the present disclosure may link the personalized settings with the boarding position of the passenger to thus implement the personalized linkage function only at the boarding position of the passenger, thereby protecting the privacy of the passenger.

Furthermore, the personalization system and the personalization method according to the exemplary embodiments of the present disclosure may simplify the passenger manipulation procedure through the various types of personalized settings based on the specifications of the conventional vehicle, thereby providing the convenient user experience.

Furthermore, the personalization system and the personalization method according to the exemplary embodiments of the present disclosure may only change the control logic, thereby providing the user with the plentiful personalized linkage function, and enhancing the luxurious feeling of the vehicle without increasing the cost.

The various embodiments of the present disclosure describe representative aspects of the present disclosure rather than enumerating all possible combinations thereof, and also the contents described in the various embodiments may be applied alone or in combination of two or more.

Although the exemplary embodiments of the present disclosure have been described hereinabove, the scope of the present disclosure is not limited thereto, and all equivalent modifications easily modified by those skilled in the art to which the present disclosure pertains are intended to fall within the scope and spirit of the present disclosure.

What is claimed is:

1. A personalization system for a vehicle, the system comprising:
a communication device; and
a controller operatively connected to the communication device,
wherein the communication device detects a position of a personal identification (ID) device carriable by a passenger and receives ID of the personal ID device from the personal ID device carriable by the passenger; and
wherein the controller:
determine a seat occupied by the passenger based on the position of the personal ID device detected by the communication device,
compare the ID of the personal ID device received by the communication device with at least one pre-stored ID of the personal ID device linked with personalized settings corresponding to a vehicle seat, and
generate a control signal for executing the personalized settings linked with a target ID in the determined seat occupied by the passenger in response to the ID of the personal ID device received by the communication device being the same as the target ID among the at least one pre-stored ID of the personal ID device.

2. The system of claim 1,
wherein a type of the personalized settings includes at least one of seat settings, air conditioning settings, and sound settings,
wherein the seat settings include at least one of settings for a front/rear position, a high/low position, a backrest inclination angle, a lumbar support position, a leg support position, a headrest position, seating comfort, massage intensity, and a massage type,
wherein the air conditioning settings include at least one of settings for a target temperature, wind power, an air blowing type, an air vent angle, and PM filtering, and
wherein the sound settings include at least one of settings for classical music, pop music, accent enhancement, and vocal enhancement among sound effects, intensity of a high-frequency range and a low-frequency range, and sound intensity.

3. The system of claim 1, wherein the controller:
determines whether the personal ID device is stationary when determining the seat occupied by the passenger,
determines whether the personal ID device is continuously stationary for a reference time based on determining that the personal ID device is stationary,
determines whether a currently detected position of the personal ID device falls within a vehicle seat region based on determining that the personal ID device is continuously stationary for the reference time, and
determines the currently detected position of the personal ID device as the seat occupied by the passenger based on determining that the currently detected position of the personal ID device falls within the vehicle seat region.

4. The system of claim 3, wherein the controller determines whether the personal ID device is stationary based on whether a change occurs in the position of the personal ID device detected by the communication device when determining whether the personal ID device is stationary.

5. The system of claim 3, wherein the controller:
receives motion information of the personal ID device detected by a motion sensor disposed inside the personal ID device when determining whether the personal ID device is stationary, and
determines whether the personal ID device is stationary based on the received motion information of the personal ID device.

6. The system of claim 3, wherein the controller determines the seat occupied by the passenger based on a seat close to a door switched to an open state and/or the seat occupied by the passenger based on that the currently detected position of the personal ID device does not fall within the vehicle seat region and falls within a region between front seats or a region between rear seats, and based on that one of the front doors or one of rear doors is determined to be switched to the open state.

7. The system of claim 6, wherein the controller determines the position of the personal ID device initially detected in a vehicle interior as the seat occupied by the passenger based on that both the front doors or both the rear doors are switched to the open state.

8. The system of claim 1, wherein the controller:
determines whether a vehicle state satisfies a personalization execution condition before determining the seat occupied by the passenger, and
determines that the vehicle state satisfies the personalization execution condition based on that the vehicle is in a parking gear, a parking brake is turned on, and power is in an ignition-on state.

9. The system of claim 1, wherein the controller controls the communication device to detect the position of the personal ID device in response to determining that any door of the vehicle is switched from a closed state to an open state.

10. The system of claim 1, wherein the controller:
transmits a personalization execution notification message when the control signal is generated;
determines whether a manipulation by the passenger for canceling the personalization execution is received; and
transmits no control signal based on determining that the manipulation by the passenger for canceling the personalization execution is received.

11. A personalization method for a vehicle, the method comprising:
detecting, by a controller, a position of a personal identification (ID) device carriable by a passenger;
receiving, by the controller, ID of the personal ID device from the personal ID device carriable by the passenger;
determining, by the controller, a seat occupied by the passenger based on the detected position of the personal ID device;
comparing, by the controller, the received ID of the personal ID device with at least one pre-stored ID of the personal ID device linked with personalized settings corresponding to a vehicle seat; and
generating, by the controller, a control signal for executing the personalized settings linked with a target ID in the determined seat occupied by the passenger in response to the ID of the personal ID device being the same as the target ID among the at least one pre-stored ID of the personal ID device.

12. The method of claim 11,
wherein a type of the personalized settings includes at least one of seat settings, air conditioning settings, and sound settings,
wherein the seat settings include at least one of settings for a front/rear position, a high/low position, a backrest inclination angle, a lumbar support position, a leg support position, a headrest position, seating comfort, massage intensity, and a massage type,
wherein the air conditioning settings include at least one of settings for a target temperature, wind power, an air blowing type, an air vent angle, and PM filtering, and
wherein the sound settings include at least one of settings for classical music, pop music, accent enhancement, and vocal enhancement among sound effects, intensity of a high-frequency range and a low-frequency range, and sound intensity.

13. The method of claim 11, wherein the determining of the seat occupied by the passenger comprises:
determining whether the personal ID device is stationary,
determining whether the personal ID device is continuously stationary for a reference time based on determining that the personal ID device is stationary,
determining whether the currently detected position of the personal ID device falls within a vehicle seat region based on determining that the personal ID device is continuously stationary for the reference time, and
determining a currently detected position of the personal ID device as the seat occupied by the passenger based on determining that the currently detected position of the personal ID device falls within the vehicle seat region.

14. The method of claim 13, wherein the determining of whether the personal ID device is stationary comprises:
determining whether the personal ID device is stationary based on whether a change occurs in the detected position of the personal ID device.

15. The method of claim 13, wherein the determining of whether the personal ID device is stationary comprises:
receiving motion information of the personal ID device detected by a motion sensor disposed inside the personal ID device, and
determining whether the personal ID device is stationary based on the received motion information of the personal ID device.

16. The method of claim 13, wherein the determining of the seat occupied by the passenger comprises:
determining the seat occupied by the passenger based on a seat close to a door switched to an open state and/or the seat occupied by the passenger based on that the currently detected position of the personal ID device does not fall within the vehicle seat region and falls within a region between front seats or a region between rear seats, and based on that one of the front doors or one of the rear doors is determined to be switched to the open state.

17. The method of claim 16, wherein the determining of the seat occupied by the passenger comprises:
determining the position of the personal ID device initially detected in a vehicle interior as the seat occupied by the passenger based on that both the front doors or both the rear doors are switched to the open state.

18. The method of claim 11, further comprising:
determining whether a vehicle state satisfies a personalization execution condition before the determining of the seat occupied by the passenger is performed; and
determining that the vehicle state satisfies the personalization execution condition based on that the vehicle is in a parking gear, a parking brake is turned on, and power is in an ignition-on state.

19. The method of claim 11, wherein the detecting of the position of the personal ID device comprises:
detecting the position of the personal ID device in response to determining that any door of the vehicle is switched from a closed state to an open state.

20. The method of claim 11, further comprising:
transmitting a personalization execution notification message based on that the control signal is generated;
determining whether a manipulation by the passenger for canceling the personalization execution is received; and
transmitting no control signal based on determining that the manipulation by the passenger for canceling the personalization execution is received.
